(19) United States
(12) Patent Application Publication
(10) Pub. No.: US 2009/0174305 A1
(43) Pub. Date: Jul. 9, 2009

(54) Phosphor paste composition, phosphor layer obtained from the same, and electron emission device including the phosphor layer

(76) Inventors: Jin-Hyoung Seo, Suwon-si (KR); Yong-Chan You, Suwon-si (KR); Sang-Hyuk Lee, Suwon-si (KR); Sun-Hwa Kwon, Suwon-si (KR); Su-Yong Nam, Busan (KR); Jong-Wook Lee, Hwaseong-si (KR)

Correspondence Address: CHRISTIE, PARKER & HALE, LLP, PO BOX 7068, PASADENA, CA, 91109-7068, US

(21) Appl. No.: 12/315,644

(22) Filed: Dec. 5, 2008

(30) Foreign Application Priority Data
Jan. 3, 2008 (KR) 10-2008-0000702

(51) Int. Cl. H01J 1/62; C09K 11/02

(52) U.S. Cl. 313/483; 252/301.36

(57) ABSTRACT

Phosphor paste compositions, phosphor layers and electron emitting devices are provided. The phosphor paste composition includes a phosphor, a binder including a photocurable monomer and an acrylic resin with an acid value ranging from about 150 mgKOH/g to about 200 mgKOH/g, a photoinitiator, and a solvent. The phosphor layer is obtained from the phosphor paste composition, and the electron emission device includes the phosphor layer. The phosphor paste compositions provide superior phosphor layer pattern resolution, plasticity, printability, and storage stability.

### CROSS-REFERENCE TO RELATED PATENT APPLICATION

This application claims priority to and the benefit of Korean Patent Application No. 10-2008-0000702, filed on Jan. 3, 2008 in the Korean Intellectual Property Office, the entire content of which is incorporated herein by reference.

### BACKGROUND OF THE INVENTION

1. Field of the Invention

The present invention relates to phosphor paste compositions, phosphor layers obtained from the same, and electron emission devices including the phosphor layers. More particularly, the invention is directed to a phosphor paste composition including an acrylic resin with an acid value.

2. Description of the Related Art

An electron emission device emits electrons in response to an electric field generated by the application of a voltage between a cathode (an electron emission source) and an anode. As a result, light is emitted when electrons emitted by the cathode collide with a phosphor layer formed on the anode.

The phosphor layer is manufactured by applying a phosphor paste composition on a substrate where the phosphor layer is to be formed. Then, a latent image is formed on the applied phosphor paste by UV exposure in a phosphor layer pattern using a photomask or the like. The resultant product is then developed and heat-treated to complete the phosphor layer. The heat-treatment process is a process of combusting various organic materials (except the phosphors) within the phosphor paste composition in order to practically retain the phosphors within the phosphor layer.

A conventional phosphor layer included in an electron emission device is formed by preparing a slurry, and applying the slurry to an entire substrate including a phosphor layer forming area by spin coating, and then performing photolithography and heat-treatment. However, the conventional slurry method of forming a phosphor layer uses spin coating, and thus, the leveling properties are poor in large screens of 15 inches or more, possibly reducing screen brightness. Furthermore, the slurry method cannot be used with SrGa₂S₄:Eu-based phosphors (e.g., (SrₓBa₁₋ₓ)Ga₂S₄:Eu phosphors or (SrₓCa₁₋ₓ)Ga₂S₄:Eu phosphors (where x ranges from 0.5 to 1)), which have twice the emission brightness of conventional Zn-based phosphors.

### SUMMARY OF THE INVENTION

In one embodiment of the present invention, a phosphor paste composition has superior resolution of the phosphor pattern and superior heat-treatment properties. In addition, the composition has improved printability and storage stability, and provides a phosphor layer with substantially no carbon deposits, thereby achieving high brightness and enabling application to large screens. According to another embodiment of the present invention, a phosphor layer is obtained from the phosphor paste composition. In yet another embodiment, an electron emission device includes the phosphor layer.

According to one embodiment of the present invention, a phosphor paste composition includes a phosphor, a binder including an acrylic resin with an acid value ranging from about 150 mgKOH/g to about 200 mgKOH/g and a photocurable monomer, a photoinitiator, and a solvent.

According to another embodiment of the present invention, a phosphor layer is obtained from the phosphor paste composition.

According to another embodiment of the present invention, an electron emission layer includes the phosphor layer obtained from the phosphor paste composition.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The above and other features and advantages of the present invention will become more apparent by reference to the following detailed description when considered in conjunction with the attached drawings in which:

FIG. 1A is a scanning electron microscope (SEM) image at 3000× magnification of one embodiment of a red phosphor for inclusion in a phosphor paste composition according to an embodiment of the present invention;

FIG. 1B is a SEM image at 3000× magnification of one embodiment of a green phosphor for inclusion in a phosphor paste composition according to an embodiment of the present invention;

FIG. 1C is a SEM image at 3000× magnification of one embodiment of a blue phosphor for inclusion in a phosphor paste composition according to an embodiment of the present invention;

FIG. 2A is a SEM image at 15000× magnification of one embodiment of a red phosphor for inclusion in a phosphor paste composition according to an embodiment of the present invention;

FIG. 2B is a SEM image at 15000× magnification of one embodiment of a green phosphor for inclusion in a phosphor paste composition according to an embodiment of the present invention;

FIG. 2C is a SEM image at 15000× magnification of one embodiment of a blue phosphor for inclusion in a phosphor paste composition according to an embodiment of the present invention;

FIG. 3 is a thermo gravimetric analysis (TGA) graph of an embodiment of an acrylic resin for inclusion in a phosphor paste composition according to an embodiment of the present invention;

FIG. 4 is a schematic perspective view of an electron emission device according to one embodiment of the present invention;

FIG. 5 is a cross-sectional view of the electron emission device of FIG. 4 taken along line II-II;

FIG. 6A is an electron microscope image of a phosphor layer pattern obtained after printing, exposing, and developing phosphor paste composition 4G;

FIG. 6B is an electron microscope image of a phosphor layer pattern obtained after printing, exposing, and developing phosphor paste composition 5G;

FIG. 6C is an electron microscope image of a phosphor layer pattern obtained after printing, exposing, and developing phosphor paste composition 7G;

FIG. 7A is an electron microscope image of a phosphor layer pattern obtained after printing, exposing, and developing phosphor paste composition 6G;

FIG. 7B is an electron microscope image of a phosphor layer pattern obtained after printing, exposing, and developing phosphor paste composition 6R;

FIG. 7C is an electron microscope image of a phosphor layer pattern obtained after printing, exposing, and developing phosphor paste composition 6B;

FIG. 7D is an electron microscope image of a phosphor layer pattern obtained after overlay-printing, exposing, and developing the phosphor paste compositions 6G, 6R and 6B according to one embodiment of the present invention;

FIG. 8A is a SEM image of a phosphor layer obtained by printing, exposing, developing, and calcining phosphor paste composition 6R;

FIG. 8B is a SEM image of a phosphor layer obtained by printing, exposing, developing, and calcining phosphor paste composition 6B; and

FIG. 8C is a SEM image of a phosphor layer obtained by printing, exposing, developing, and calcining phosphor paste composition 6G.

### DETAILED DESCRIPTION OF THE INVENTION

A phosphor paste composition according to one embodiment of the present invention includes a phosphor, a binder, a photoinitiator, and a solvent. The binder includes an acrylic resin with an acid value ranging from about 150 mgKOH/g to about 200 mgKOH/g and a photocurable monomer.

The phosphor in the phosphor paste composition may be any conventional phosphor used in various electric devices, such as electron emission devices, cathode ray tubes, and flat-panel lamps. Nonlimiting examples of suitable red phosphors include ReBO₃:Eu³⁺ phosphors (where Re is at least one rare earth element selected from Sc, Y, La, Ce and Gd), Y₂O₃:Eu³⁺ phosphors and Y(V,P)0₄:Eu³⁺ phosphors. Nonlimiting examples of suitable green phosphors includes SrGa₂S₄:Eu-based phosphors (such as (SrₓBa₁₋ₓ)Ga₂S₄:Eu phosphors or (SrₓCa₁₋ₓ)Ga₂S₄:Eu phosphors (where x is 0.5-1)), (Zn,A)₂SiO₄:Mn phosphors (where A is an alkaline earth metal), (BaSrMg)O.aAl₂O₃:Mn phosphor (where a is 1-23), LaMgAlₓO_{y}:Tb phosphors (where x is 1-14 and y is 8-47), ReBO₃:Tb³⁺ phosphors (where Re is at least one rare earth element selected from Sc, Y, La, Ce and Gd), MgAlₓO_{y}:Mn phosphors (where x is 1-10 and y is 1-30). Nonlimiting examples of suitable blue phosphors include BaMgAlₓO_{y}:Eu²⁺ phosphors (where x is 1-10 and y is 1-30), CaMgSiₓO_{y}:Eu²⁺ phosphors (where x is 1-10 and y is 1-30), and ZnS:Ag,Al phosphors.

In particular, even when the phosphor paste composition includes a (SrₓBa₁₋ₓ)Ga₂S₄:Eu phosphor or a (SrₓCa₁₋ₓ)Ga₂S₄:Eu phosphor (where x is 0.5-1), substantially no reaction occurs between the phosphor and any of the elements of the phosphor paste component. Therefore, the phosphor paste composition has superior storage stability and printability.

The phosphor may have a mean particle diameter ranging from about 3 to about 7 μm. When the mean particle diameter of the phosphor is larger than about 3 μm, the phosphor can have a favorable dispersibility within the phosphor paste composition. When the mean particle diameter of the phosphor is smaller than about 7 μm, the phosphor can form a phosphor layer with a favorable surface roughness.

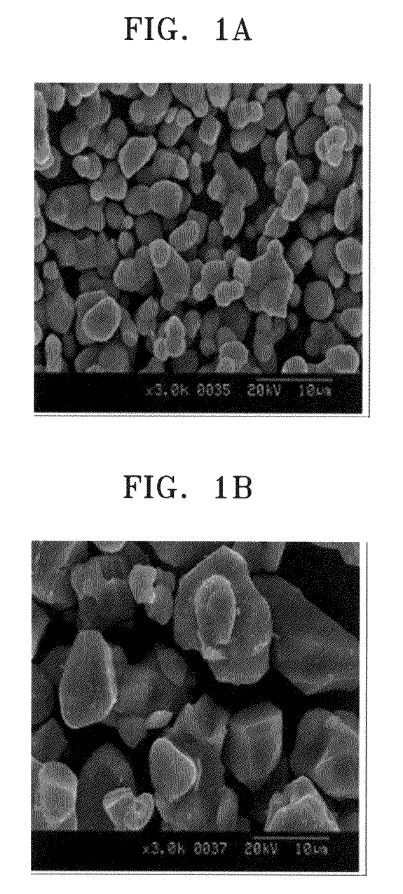

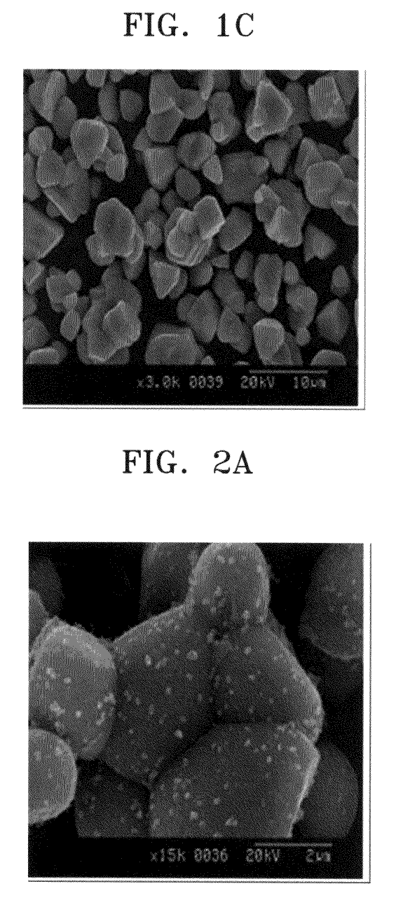

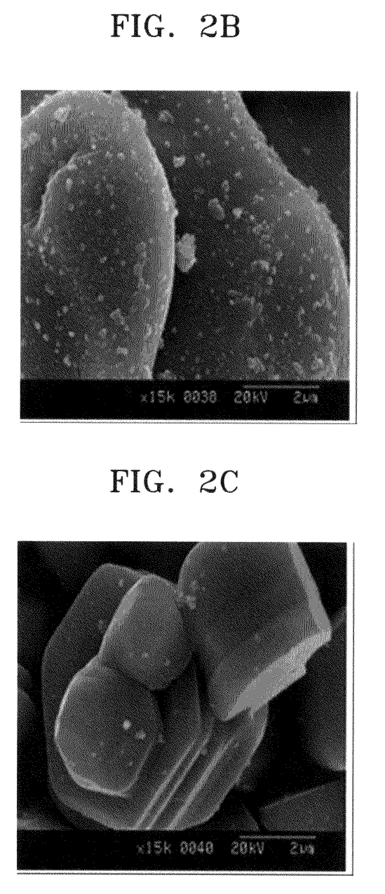

A surface of the phosphor may be coated to enhance adhesiveness between the substrate and the phosphor, and to improve the dispersion stability of the phosphors within the phosphor paste composition. Nonlimiting examples of suitable coating materials include silica, Al₂O₃, and the like. FIGS. 1A, 1B, and 1C are scanning electron microscope images (taken at 3000× magnification) of a Y₂O₃:Eu phosphor (red phosphor), a (Sr_{0.9}Ba_{0.1})Ga₂S₄:Eu phosphor (green phosphor), and a ZnS:Ag,Al phosphor (blue phosphor) respectively, in which each of phosphor has a surface coated with silica. FIGS. 2A, 2B, and 2C are scanning electron microscope images (taken at 3000× magnification) of a Y₂O₃:Eu phosphor (red phosphor), a (Sr_{0.9}Ba_{0.1})Ga₂S₄:Eu phosphor (green phosphor), and a ZnS:Ag,Al phosphor (blue phosphor) respectively, in which each of phosphor has a surface coated with silica. A phosphor paste composition according to an embodiment of the present invention includes a binder which includes an acrylic resin with an acid value ranging from about 150 mgKOH/g to about 200 mgKOH/g and a photocurable monomer. The acrylic resin may have a hydrophilic substituent group such as —COOH, —OH, —SO₂H, —SO₂NH₂, —SO₂NHCOCH₃, —(CH₂)SO₂H, —SO₃H, —PO₃NH₂, —PO₃H₂, —NH₂ or —N(CH₃)₂. Because the acrylic resin has an acid value ranging from 150 mgKOH/g to 200 mgKOH/g, an unexposed area of the phosphor paste composition including the acrylic resin can be easily developed by a hydrophilic solution (such as an alkaline solution) after exposure with a phosphor pattern. Therefore, the phosphor paste composition including the acrylic resin may provide superior pattern resolution.

The acrylic resin may have a weight-average molecular weight ranging from about 15,000 to about 30,000, and in one embodiment, the acrylic resin has a weight-average molecular weight ranging from about 20,000 to about 30,000. When the weight-average molecular weight of the acrylic resin is greater than about 15,000, a favorable hardness of the phosphor layer can be obtained. When the weight-average molecular weight of the acrylic resin is less than about 30,000, a favorable viscosity of the phosphor paste composition can be obtained, and a relatively low temperature can be used for heat-treatment.

The glass transition temperature of the acrylic resin may range from about 50 to about 100° C., and in one embodiment, the glass transition temperature ranges from about 70 to about 90° C. When the glass transition temperature of the acrylic resin is higher than about 50° C., a favorable printability can be obtained. When the glass transition temperature is lower than about 100° C., a relatively low temperature can be used for heat-treatment.

The acrylic resin is a non-photocurable resin. That is, when exposing the phosphor paste composition, the acrylic resin is not substantially involved in a curing reaction.

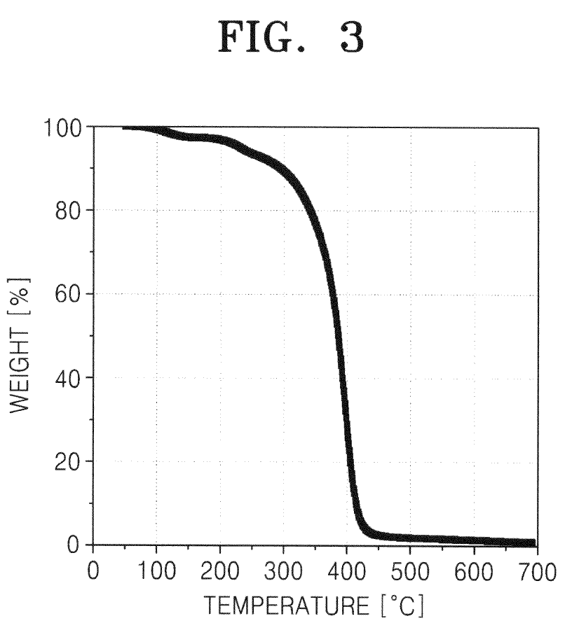

FIG. 3 is a thermo gravimetric analysis (TGA) graph (heat-treated under air atmosphere) of an MMA resin with an acid value of 150 mgKOH/g, a weight-average molecular weight of 20,000, and a glass transition temperature of 80° C. (A/A4123 by SK Cytec Co) according to one embodiment of the acrylic resin. Referring to FIG. 3, it can be seen that the acrylic resin is at least about 98% heat-treated below a temperature of about 450° C. in air atmosphere, and is at least about 99% heat-treated below a temperature of about 490° C. Therefore, the phosphor paste composition including such an acrylic resin according to the present invention has superior heat-treatment properties such that almost no carbon deposits may remain in the phosphor layer after heat-treatment. Therefore, a phosphor layer with superior brightness can be obtained. As used herein, “carbon deposit” refers to various materials that remain in the phosphor layer (except for the phosphor) after heat-treating the phosphor layer patterns obtained from printing, exposing, and developing of the phosphor paste composition.

The photocurable monomer within the phosphor paste composition forms a phosphor layer pattern through a curing reaction during exposure. The photocurable monomer may include at least one functional group participating in the curing reaction.

The photocurable monomer may be, for example, an acrylate-based monomer. Acrylate-based monomers containing an aromatic group (such as a benzene group) can cause an increase in carbon deposit content after exposure and heat-treatment. Nonlimiting examples of suitable photocurable monomers include 2-hydroxypropyl acrylate(HPA), 4-hydroxybutyl acrylate(4-HBA), polyethyleneglycol diacrylate(9EGDA), neopentylglycol hydroxypivalate diacrylate modified caprolactone, bisphenol A diacrylate, modified EO(R-551), trimethylolpropane triacrylate(TMPTA), trimethylolpropane triacrylate modified EO (when the number of included ethylene oxides is 3 (TMP3EOTA), 6 (TMP6EOTA), or 9 (TMP9EOTA)), dipentaerythritol triacrylate, pentaerythritol triacrylate (PETA), ditrimethylolpropane tetraacrylate (DTMPTA), dipentaerythritol hexaacrylate (DPHA), dipentaerythritol hexaacrylate modified caprolactone, and combinations thereof. In one embodiment, the acrylate-based monomer is an ethylene oxide (—OC2H4), DPHA, or TMPTA. For example, DPHA, TMPTA, and TMP9EOTA may be used in combination at a weight ratio of 1:1:1.

The photocurable monomer may be present in an amount ranging from about 50 to about 90 parts by weight, and in one embodiment, from about 60 to about 80 parts by weight based on 100 parts by weight of the acrylic resin. When the photocurable monomer is present in an amount greater than about 50 parts by weight based on 100 parts by weight of the acrylic resin, a network structure is sufficiently formed by a curing reaction of the photocurable monomer during exposure, and thus a phosphor layer with a favorable strength can be obtained, and dissolution of the exposed area by a developing agent and delamination can be prevented during development. When the photocurable monomer is present in an amount less than about 90 parts by weight based on 100 parts by weight of the acrylic resin, the surface of the phosphor can be sufficiently covered with the binder due to an appropriate mix of the contents of the acrylic resin, enabling favorable phosphor dispersibility in the phosphor paste composition, and providing improved developability and adhesiveness, such that an unexposed part is easily developed during development after exposure.

The binder (including the acrylic resin and the photocurable monomer) may be present in an amount ranging from about 20 to about 60 parts by weight, and in one embodiment from about 30 to about 50 parts by weight based on 100 parts by weight of the phosphor within the phosphor paste composition. When the binder is present in an amount greater than about 20 parts by weight based on 100 parts by weight of the phosphor, the phosphor within the phosphor layer is packed less compactly, thereby preventing decreases in porosity between the phosphors, and good printability can be obtained by maintaining an appropriate viscosity of the phosphor paste composition, thereby preventing excessive increases in the thickness of the phosphor layer, and obtaining a phosphor layer with superior emission brightness. Conversely, when the binder is present in an amount less than about 60 parts by weight based on 100 parts by weight of the phosphor, a phosphor paste composition with a favorable viscosity can be obtained, preventing spreading and cratering of the phosphor paste composition during printing, and preventing separation of the phosphor and binder components, thereby also preventing formation of mesh marks on the printed product of the phosphor paste composition and empty spaces where the phosphor does not exist. As a result, the brightness and reliability of the phosphor layer can be improved.

The photoinitiator within the phosphor paste composition initiates the curing of the photocurable monomers. Non-limiting examples of suitable photoinitiators include 1-hydroxy-cyclohexyl-phenylketone, benzophenone, 2-benzyl-2-dimethylamino-1-(4-morpholinophenyl)butanone-1, bis(2,4,6-trimethylbenzoyl)-phenylphosphineoxide, 2-methyl-1[4-methylthio]phenyl-2-morpholinopropan-1-one, 2,4,6-trimethylbenzoyl phenyl ethoxyphosphine oxide (TPO), 2,4-diethylthioxanthone (DETX), isopropyl thioxanthone (ITX), 2-hydroxy-2-methyl-1-phenyl-propan-1-one, and combinations thereof. In one embodiment for example, the photoinitiator is selected from 2,4-diethylthio xanthone (DETX), isopropyl thioxanthone (ITX), and combinations thereof.

The photoinitiator may be present in an amount ranging from about 1 to about 10 parts by weight, and in one embodiment from about 2 to about 7 parts by weight based on 100 parts by weight of the phosphor within the phosphor paste composition. When the photoinitiator is present in an amount greater than about 1 part by weight based on 100 parts by weight of the phosphor, a curing reaction is effectively initiated during exposure, and a network structure is sufficiently formed by the curing reaction of the photocurable monomers, thereby forming a clear phosphor layer pattern and obtaining a phosphor layer with superior strength. Moreover, when the photoinitiator is present in an amount less than about 10 parts by weight based on 100 parts by weight of the phosphor, an increase in the carbon deposit content after heat-treatment can be prevented.

The solvent within the phosphor paste composition controls viscosity, fluidity, and printability of the phosphor paste composition. Nonlimiting examples of suitable solvents include terpineol, texanol, butyl carbitol acetate (BCA), butyl carbitol (BC), ethyl cellosolve acetate (ECA), and combinations thereof. In one embodiment, for example, terpineol (for example, α-terpineol: CH₃C₆H₈C(CH₃)₂OH) may be used as the solvent.

The solvent may be present in an amount ranging from about 5 to 40 parts by weight, and in one embodiment, for example, from about 10 to about 35 parts by weight based on 100 parts by weight of the phosphor within the phosphor paste composition. When the solvent is present in an amount outside these ranges, the viscosity of the phosphor paste composition becomes too high or too low, thereby degrading the printability of the phosphor paste composition.

In addition, the phosphor paste composition may further include a dispersant. The dispersant evenly disperses the solid powder such as the phosphor and acrylic resin within the phosphor paste composition, lowers the carbon deposit content after heat-treatment, and improves the fluidic properties of the phosphor paste composition. Nonlimiting examples of suitable dispersants include aqueous/oil-soluble wet dispersants having high molecular weight, such as dispersants with a denatured polyether solution as the main component with a pigment affinity functional group.

The dispersant may be present in an amount ranging from about 0.5 to about 4 parts by weight, and in one embodiment, for example, from about 1 to about 3 parts by weight based on 100 parts by weight of the phosphor. When the dispersant is present in an amount greater than about 0.5 parts by weight based on 100 parts by weight of the phosphor, the dispersing properties of the phosphor paste composition can be improved. When the dispersant is present in an amount less than about 4 parts by weight based on 100 parts by weight of the phosphor, favorable storage stability can be obtained.

Moreover, the phosphor paste composition may further include octanol. Octanol enhances the leveling performance of the phosphor paste composition and improves the strength of the phosphor layer. Octanol may be present in an amount ranging from about 0.1 to about 0.6 parts by weight, and in one embodiment, for example, from about 0.2 to about 0.5 parts by weight based on 100 parts by weight of the phosphor within the phosphor paste composition. When octanol is present in an amount greater than about 0.1 parts by weight based on 100 parts by weight of the phosphor, good developability can be obtained, and substantially no carbon deposits may remain within the phosphor layer. When octanol is present in an amount less than about 0.6 parts by weight based on 100 parts by weight of the phosphor, the viscosity of the phosphor paste composition can be maintained at a suitable level, thereby obtaining a favorable printability.

By printing, exposing, developing, and heat-treating the phosphor paste composition, a phosphor layer may be formed for use in diverse electronic devices such as electron emission devices.

First, the phosphor paste composition as previously described is prepared. Here, the components included in the phosphor paste composition and amounts thereof are as described above. Then, the phosphor paste composition is printed on the substrate including the area on which the phosphor layer is to be formed. The substrate may be, for example, an anode (in the case of an electron emission device). Then, the printed phosphor paste composition is exposed using a pattern of the phosphor layer, and then is developed. A photomask and/or a UV mask may be used when exposing. An alkaline solution, such as Na₂CO₃, NaHCO₃, K₂CO₃, K₂HCO₃, (NH₄)₂CO₃, or (NH₄)HCO₃, may be used as a developing solution. The phosphor paste composition may include an acrylic resin with an acid value as previously described so that the composition can be effectively developed by the alkaline solution. Thereby, superior pattern development can be obtained.

Then, the exposed and developed product is heat-treated to calcine various organic materials, such as the binder (which includes the acrylic resin and the cured photocurable monomers). Accordingly, a phosphor layer made of phosphor is formed. Before heat-treatment, the solvent may first be evaporated by drying the exposed and developed product at a temperature of about 150° C. for about 3 hours. The heat-treating temperature may vary depending on the different components included in the phosphor paste composition, but in some embodiments may be performed at a temperature ranging from about 400 to about 500° C. for from about 0.5 to about 3 hours in an air atmosphere. If the heat-treating temperature is below the above range, or if the time of heat-treating is below the above range, various organic materials included in the exposed and developed product are not calcined effectively, and may increase the carbon deposit content remaining in the phosphor layer. Conversely, if the heat-treating temperature is too high or if the time of heat-treating is too long, the phosphor itself within the phosphor paste composition may be damaged.

The electron emission device may be used as an electron emission display device. Alternatively, the electron emission device may be used in different applications, such as a backlight unit in various types of electronic devices, such as a liquid crystal display (LCD).

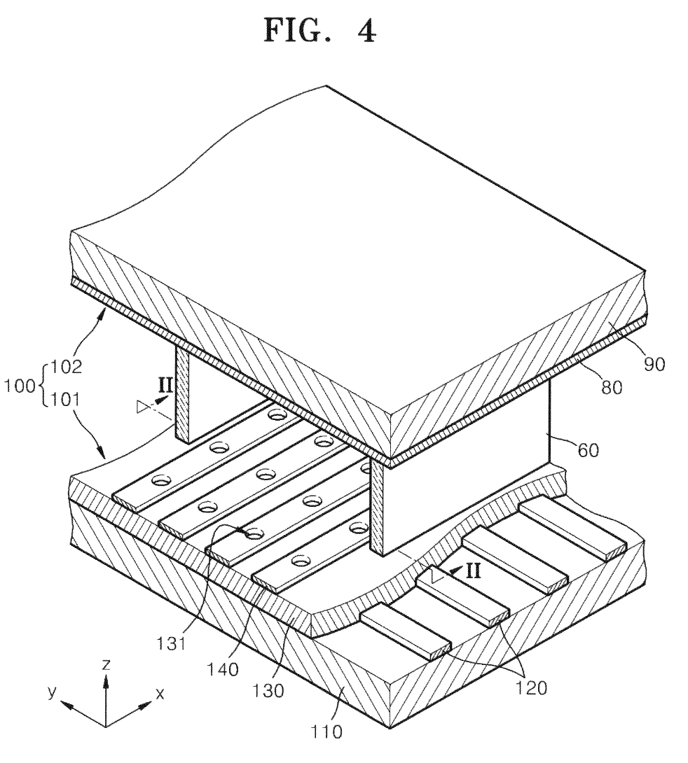

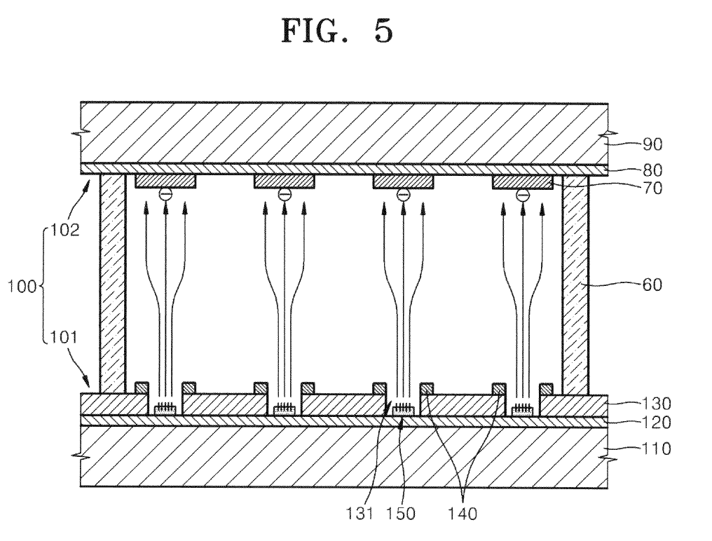

FIG. 4 is a schematic perspective view of an electron emission device according to an embodiment of present invention including the phosphor layer formed using a phosphor paste composition according to an embodiment of the present invention. FIG. 5 is a cross-sectional view of the electron emission device shown in FIG. 4.

An electron emission device according to one embodiment of the present invention may include a first substrate, a plurality of cathodes disposed on the first substrate, a plurality of gate electrodes intersecting the cathodes, an insulation layer between the cathodes and gate electrodes for insulating the cathodes from the gate electrodes, electron emitting source holes formed in the areas where the cathodes and gate electrodes intersect, electron emission sources disposed in the electron emitting source holes, a second substrate disposed substantially in parallel with the first substrate, an anode disposed on the second substrate, and a phosphor layer disposed on the anode.

As shown in FIGS. 4 and 5, an electron emission device 100 includes a first panel 101 and a second panel 102, and a spacer 60 which maintains a gap between the first panel 101 and the second panel 102. The first panel 101 includes a first substrate 110, gate electrodes 140 and cathodes 120 intersecting each other on the first substrate 110, an insulation layer 130 between the gate electrodes 140 and the cathodes 120 for electrically insulating the gate electrodes 140 and the cathodes 120.

The regions where the gate electrodes 140 and the cathodes 120 intersect have electron emission source holes 131 formed therein, and electron emission sources 150 are disposed within the holes 131. The electron emission sources 150 may be electron emission materials, which may include carbon-based materials such as carbon nanotubes.

The second panel 102 includes a second substrate 90, an anode 80 disposed on the second substrate 90, and a phosphor layer 70 disposed on the anode 80. The phosphor layer 70 is formed using a phosphor paste composition according to an embodiment of the present invention, and has good pattern sharpness and contains almost no carbon deposit, thereby providing superior brightness.

While the electron emission device according to embodiments of the present invention have been described with reference to the FIGS. 4 and 5, it is understood that various modifications may be made, such as further including a second insulation layer and/or a focusing electrode.

The following Examples are presented for illustrative purposes only, and do not limit the scope of the invention.

### EXAMPLES

### Example

### Preparation of Phosphor Paste Composition

Phosphor paste compositions 1R to 7R were prepared according to the components and the content ratios shown in Table 1 below:

TABLE 1

| | Composition No. | | | | | | |
|---|---|---|---|---|---|---|---|
| | 1R | 2R | 3R | 4R | 5R | 6R | 7R |
| Acrylic resin | 12.8 | 12.8 | 12.8 | 12.8 | 12.8 | 12.8 | 12.8 |
| Solvent | 19.2 | 19.2 | 19.2 | 19.2 | 19.2 | 19.2 | 19.2 |
| (α-terpineol) | | | | | | | |
| Photocurable monomer | 2.65 | 3.45 | 4 | 2.65 | 2.65 | 2.65 | 2.65 |
| (TMP9EOTA) | | | | | | | |
| Photocurable monomer | 2.65 | 3.45 | 4 | 2.65 | 2.65 | 2.65 | 2.65 |
| (TMPTA) | | | | | | | |
| Photocurable monomer | 2.7 | 1.1 | — | 2.7 | 2.7 | 2.7 | 2.7 |
| (DPHA) | | | | | | | |
| Phosphor | 60 | 60 | 60 | 60 | 60 | 60 | 60 |
| (Y₂O₃:Eu) | | | | | | | |
| Photoinitiator | 2 | 3 | 3 | 3 | 3 | 3 | 4 |
| (FA9009) | | | | | | | |
| Octanol | — | — | — | 0.25 | 0.25 | 0.25 | 0.25 |
| Dispersant | — | — | — | — | 1 | 1.5 | 2.0 |
| (Dispers 651) | | | | | | | |

In Table 1, the figures are reported in parts by weight. The range of figures refer to the weight ratio of each component. For example, composition 1R includes the acrylic resin, α-terpineol, TMP9EOTA, TMPTA, DPHA, a phosphor, and a photoinitiator at a weight ratio of 12.8:19.2:2.65:2.65:2.7:60:2.

In Table 1, the acrylic resin is an MMA-based resin (A/A4123 by SK Cytec Co.), with an acid value of 150 mgKOH/g, a weight-average molecular weight of 20,000, and a glass transition temperature of 80° C. The TMP9EOTA, TMPTA and DPHA can be obtained from SK Cytec Co.

In Table 1, Y₂O₃:Eu is a red phosphor, a surface of which is coated with silica, and can be obtained from Samsung SDI Co.

In Table 1, FA9009 used as the photoinitiator is a mixture of DETX-S and ITX, and the solvent is terpineol, and can be obtained from SK Cytec Co.

In Table 1, octanol can be obtained from Sigma Aldrich Co.

In Table 1, Dispers 651 used as the dispersant is a polyether modified with a pigment affinity group, and can be obtained from TEGO Co.

Phosphor paste compositions 1G to 7G were prepared according to the components and the content ratios shown in Table 1 except that a green phosphor, i.e. (Sr_{0.9}Ba_{0.1})Ga₂S₄:Eu, surface coated with silica, was used as the phosphor instead of Y₂O₃:Eu. Phosphor paste compositions 1B to 7B were prepared according to the components and content ratios shown in Table 1 except that a blue phosphor, i.e. ZnS:Ag,Al, surface coated with silica, was used as the phosphor instead of Y₂O₃:Eu.

### Evaluation Example

### Evaluation of Carbon Deposit Yield

The carbon deposit yields of each of the compositions prepared above were evaluated before preparing the phosphor layers. Compositions 1 to 7 were prepared according to the components and content ratios stated in Table 1, except that the red (Y₂O₃:Eu) phosphor was not added. Composition 1 was screen printed on a substrate using a screen plate of SUS 325 mesh, and was dried at 100° C. for 5 minutes. The weight of the resulting dried product (referred to as A) was measured. Then, the dried product was exposed to UV light using a gallium lamp, and then the product was dried at 150° C. for 3 hours with the temperature increasing 5° C. per minute. The product was heat-treated at 370° C. for 20 minutes and 470° C. for 20 minutes. The weight measure of the resulting product is referred to as B. The carbon deposit yield was calculated according to the equation (B/A) X 100, and the results are shown in Table 2 below:

TABLE 2

| | Carbon Deposit Yield (%) |
|---|---|
| Composition 1 | 5.50 |
| Composition 2 | 4.40 |
| Composition 3 | 4 |
| Composition 4 | 3.26 |
| Composition 5 | 0.7 |
| Composition 6 | 0.1 |
| Composition 7 | 0 |

It can be seen from Table 2 above that the phosphor layer produced using the phosphor paste composition according to embodiments of the present invention has a very low carbon deposit yield.

### Manufacture Example

### Manufacturing the Phosphor Layer

Phosphor layers were manufactured using the phosphor paste compositions 1R to 7R, 1G to 7G, and 1B to 7B as previously described. First, the phosphor paste composition 1R was screen-printed on a substrate using a screen plate of SUS 325 mesh, and was dried at 10° C. for 5 minutes. Then, the dried product was irradiated with UV light using a gallium lamp and a phosphor layer pattern. The dried product was then developed with an alkaline solution (0.5 wt % Na₂CO₃ solution). The same method was repeated for phosphor paste compositions 2R to 7R, 1G to 7G, and 1B to 7B.

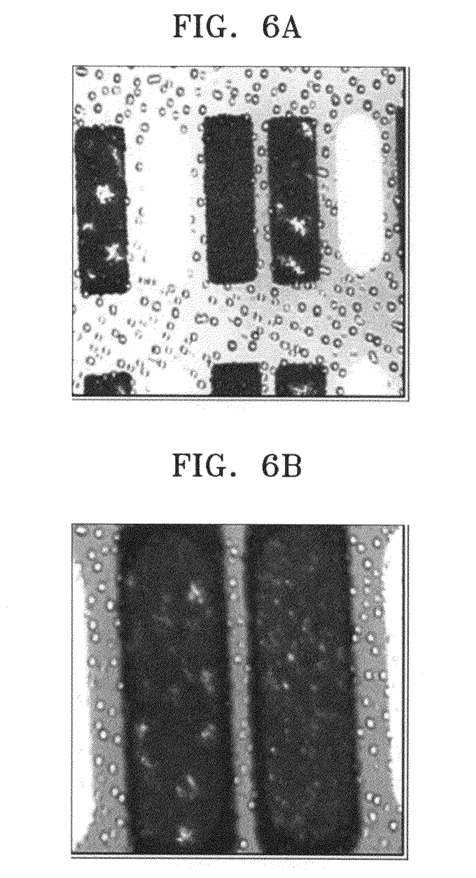

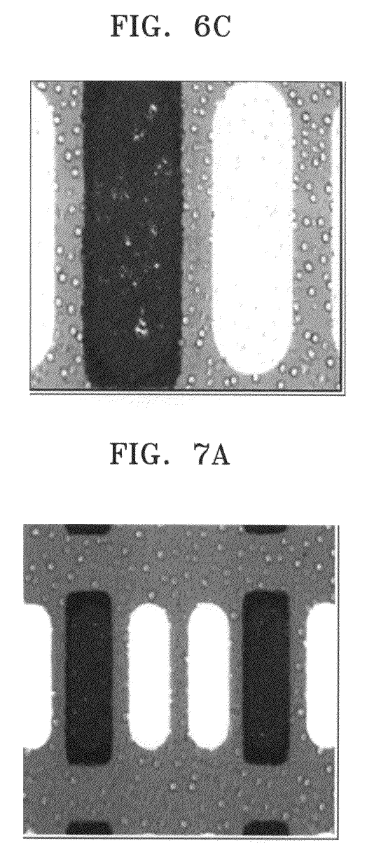

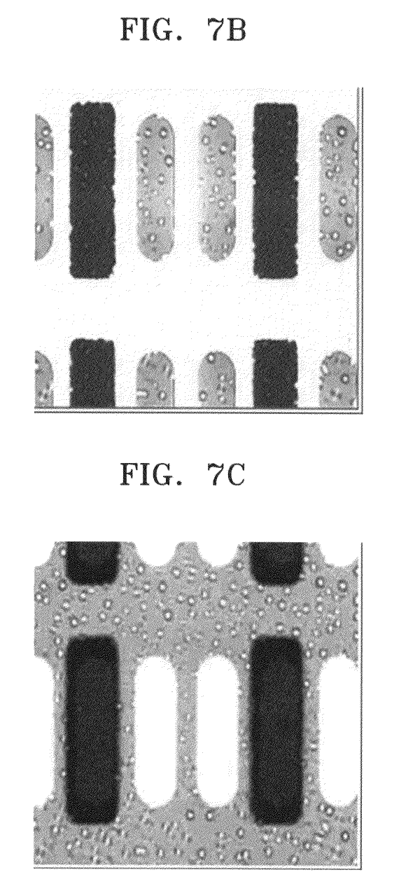

FIGS. 6A, 6B, and 6C are electron microscope images (50-fold magnification) of the phosphor layer patterns obtained by printing, exposing and developing phosphor paste compositions 4G, 5G and 7G, respectively. FIGS. 7A, 7B, and 7C are electron microscope images (50-fold magnification) of the phosphor layer patterns obtained by printing, exposing and developing phosphor paste compositions 6G, 6R and 6B, respectively. FIG. 7D is an electron microscope image (50-fold microscope) of a phosphor layer pattern obtained by overlay printing the phosphor paste compositions 6R, 6G and 6B, followed by exposing and developing. It can be seen from FIGS. 6A to 7D that the phosphor paste compositions according to embodiments of the present invention have superior pattern developability.

Phosphor paste compositions 6R, 6B, and 6G were printed, exposed and developed as previously described, then the resulting products were dried at 100° C. while increasing the temperature 5° C. per minute. The products were heat-treated at 370° C. for 20 minutes and 470° C. for 20 minutes to obtain a phosphor layer.

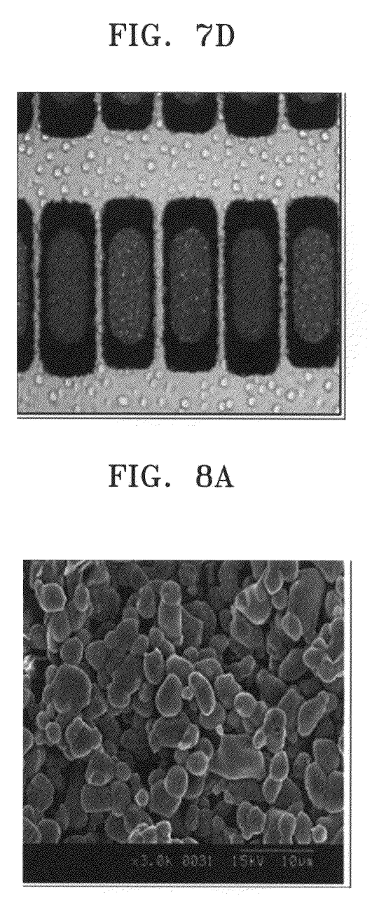

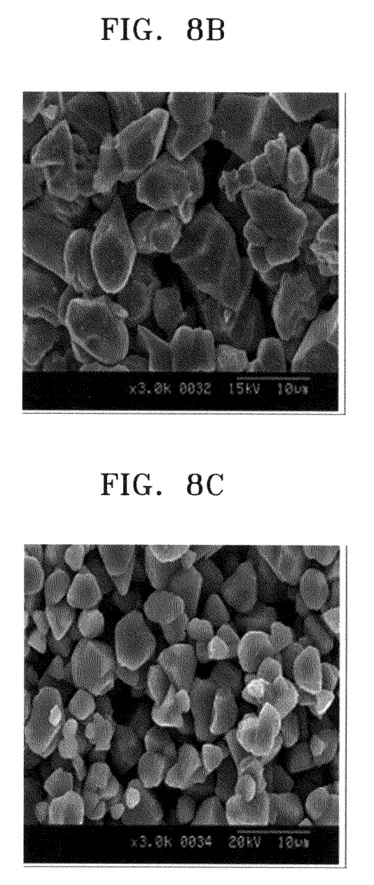

FIGS. 8A to 8C are scanning electron microscope (SEM) photographic images of the phosphor layers obtained by printing, exposing, developing, and heat-treating the phosphor paste compositions 6R, 6B, and 6G, respectively. It can be seen from FIGS. 8A to 8C that the phosphor layer was basically carbon deposit-free, confirming that the phosphor paste compositions according to embodiments of the present invention have superior heat-treatment properties.

The phosphor paste compositions according to embodiments of the present invention provide superior phosphor layer pattern resolution, heat-treatment properties, and superior printability and storage stability. Moreover, the phosphor paste compositions have superior solubility in alkaline solutions, and the binder in the phosphor paste compositions can be calcined at about 470° C. Phosphor layers obtained from such phosphor paste compositions contain substantially no carbon deposit, thereby achieving high brightness and enabling large screen applications.

While the present invention has been illustrated and described with reference to certain exemplary embodiments, it is understood by those of ordinary skill in the art that various modifications and changes may be made to the described embodiments without departing from the spirit and scope of the present invention as defined by the following claims.

What is claimed is:

1. A phosphor paste composition comprising:
a phosphor;
a binder comprising a photocurable monomer, and an acrylic resin with an acid value ranging from about 150 mgKOH/g to about 200 mgKOH/g;
a photoinitiator; and
a solvent.

2. The phosphor paste composition of claim 1, wherein a mean particle diameter of the phosphor ranges from about 3 to about 7 μm.

3. The phosphor paste composition of claim 1, wherein the phosphor is selected from the group consisting of (SrₓBa₁₋ₓ)Ga₂S₄:Eu phosphors and (SrₓCa₁₋ₓ)Ga₂S₄:Eu phosphors, wherein x ranges from 0.5 to 1.

4. The phosphor paste composition of claim 1, wherein the acrylic resin has a weight-average molecular weight ranging from about 15,000 to about 30,000.

5. The phosphor paste composition of claim 1, wherein the acrylic resin has a glass transition temperature ranging from about 50 to about 100° C.

6. The phosphor paste composition of claim 1, wherein the photocurable monomer comprises an acrylate-based monomer.

7. The phosphor paste composition of claim 1, wherein the photocurable monomer is selected from the group consisting of 2-hydroxypropyl acrylate (HPA), 4-hydroxybutyl acrylate (4-HBA), polyethyleneglycol diacrylate (9EGDA), neopentylglycol hydroxypivalate diacrylate modified caprolactone, bisphenol A diacrylate, modified EO (R-551), trimethylolpropane triacrylate (TMPTA), trimethylolpropane triacrylate modified EO, dipentaerythritol triacrylate, pentaerythritol triacrylate (PETA), ditrimethylolpropane tetraacrylate (DTMPTA), dipentaerythritol hexaacrylate (DPHA), dipentaerythritol hexaacrylate modified caprolactone, and combinations thereof.

8. The phosphor paste composition of claim 1, wherein the photocurable monomer is present in the acrylic resin in an amount ranging from about 50 to about 90 parts by weight based on 100 parts by weight of the acrylic resin.

9. The phosphor paste composition of claim 1, wherein the binder is present in the phosphor paste composition in an amount ranging from about 20 to about 60 parts by weight based on 100 parts by weight of the phosphor.

10. The phosphor paste composition of claim 1, wherein the photoinitiator is selected from the group consisting of 1-hydroxy-cyclohexyl-phenylketone, benzophenone, 2-benzyl-2-dimethylamino-1-(4-morpholinophenyl)butanone-1, bis(2,4,6-trimethylbenzoyl)-phenylphosphineoxide, 2-methyl-1 [4-methylthio]phenyl-2-morpholinopropan-1-one, 2,4,6-trimethylbenzoyl phenyl ethoxyphosphine oxide (TPO), 2,4-diethylthio xanthone (DETX), isopropyl thioxanthone (ITX), 2-hydroxy-2-methyl-1-phenyl-propan-1-one, and combinations thereof.

11. The phosphor paste composition of claim 1, wherein the photoinitiator is selected from the group consisting of 2,4-diethylthio xanthone (DETX), isopropyl thioxanthone (ITX), and combinations thereof.

12. The phosphor paste composition of claim 1, wherein the photoinitator is present in the phosphor paste composition in an amount ranging from about 1 to about 10 parts by weight based on 100 parts by weight of the phosphor.

13. The phosphor paste composition of claim 1, wherein the solvent is selected from the group consisting of terpineol, texanol, butyl carbitol acetate (BCA), butyl carbitol (BC), ethyl cellosolve acetate (ECA), and combinations thereof.

14. The phosphor paste composition of claim 1, wherein the solvent is present in the phosphor paste composition in an amount ranging from about 5 to about 40 parts by weight based on 100 parts by weight of the phosphor.

15. The phosphor paste composition of claim 1, further comprising an additive selected from the group consisting of dispersants, octanol, and combinations thereof.

16. A phosphor layer obtained from the phosphor paste composition of claim 1.

17. An electron emission device comprising:
a first substrate;
a plurality of cathodes on the first substrate;
a plurality of gate electrodes on the first substrate and intersecting the cathodes;
an insulation layer between the cathodes and gate electrodes;
an electron emitting source hole in each area where the cathodes and gate electrodes intersect;
an electron emission source inside each electron emitting source hole;
a second substrate substantially parallel to the first substrate;
an anode on the second substrate; and
a phosphor layer on the anode, wherein the phosphor layer is obtained from the phosphor paste composition of claim 1.
